(19) United States
(12) Patent Application Publication
(10) Pub. No.: US 2004/0172435 A1
(43) Pub. Date: Sep. 2, 2004

(54) Architecture and method for performing a fast fourier transform and OFDM reciever employing the same

(75) Inventor: Manish Goel, Plano, TX (US)

Correspondence Address: TEXAS INSTRUMENTS INCORPORATED, P O BOX 655474, M/S 3999, DALLAS, TX, 75265

(73) Assignee: Texas Instruments Incorporated, Dallas, TX (US)

(21) Appl. No.: 10/780,003

(22) Filed: Feb. 17, 2004

Related U.S. Application Data
(60) Provisional application No. 60/450,305, filed on Feb. 27, 2003.

(51) Int. Cl. G06F 15/00

(52) U.S. Cl. 708/404

(57) ABSTRACT

The present invention is directed to a fast Fourier transform (FFT) architecture. In one embodiment, the FFT architecture includes a pipeline segment having a plurality of data-independent pipelines that receive different time-domain data samples and generate therefrom corresponding intermediate results. Additionally, the FFT architecture also includes a parallel segment, coupled to all of the pipelines, that receives the corresponding intermediate results and generates therefrom corresponding frequency-domain results.

### CROSS-REFERENCE TO PROVISIONAL APPLICATION

This application claims the benefit of U.S. Provisional Application No. 60/450,305 entitled “A High-Speed Scalable Architecture for FFT” to Manish Goel, filed on Feb. 27, 2003, and incorporated herein by reference.

### TECHNICAL FIELD OF THE INVENTION

The present invention is directed, in general, to fast Fourier transformation and, more specifically, to an FFT architecture, method of performing an FFT and an OFDM receiver employing the same.

### BACKGROUND OF THE INVENTION

Communication systems extensively employ digital signal processing techniques to accomplish increasingly more sophisticated and complex computational algorithms. Expanding applications are being fueled by new technologies and increasing demand for products and services. The Discrete Fourier (or Frequency) Transform (DFT) is employed in many of these applications to provide a needed transformation between sampled time-domain signals (that are usually digitized) and their frequency-domain equivalents. The DFT may be calculated in three different ways. A set of simultaneous equations can be employed, but this technique is too inefficient to be of practical use. Correlation techniques can also be used, but computational requirements make this technique cumbersome or expensive to implement on a broad scale.

The Fast Fourier (or Frequency) Transform (FFT) is an ingenious algorithm first discovered by Karl Friedrich Gauss, the great German mathematician of a century ago, and rediscovered and applied by J. W. Cooley and J. W. Tukey in 1965. The FFT is typically hundreds of times faster than the other DFT methods mentioned above and is therefore the algorithm of choice for a broad spectrum of applications employing the DFT. For example, the FFT is a critical element of a digital communication system that employs Orthogonal Frequency Division Multiplexing (OFDM) or Discrete Multitone (DMT) techniques.

The FFT is based on a “divide and conquer” model that decomposes a DFT into N points, which actually correspond to N separate DFTs consisting of a single point. The whole transform is then obtained from these simpler transforms. For example, an N-point DFT computation can be divided into two N/2-point DFT computations that can be further divided into two N/4-point DFT computations, and so on until complete. Actually, the division occurs after a reorganization of the points, such that each point corresponds to a two-point DFT in each position when using a method based on radix-2. After this division and DFT computation, a merging process is performed in which the simpler DFT transforms are reassembled into the complete DFT transform. A basic computational element employed in the FFT is called a butterfly structure, which accepts two complex input numbers and performs one complex multiplication, one complex addition and one complex subtraction to produce two complex output numbers.

Pipelined FFT processors represent a specialized class of architectures for application specific, real-time DFT computation that use these fast algorithms and butterfly structures. They are characterized by continuous processing that employs a processor clock, synchronized with input data sampling, to produce one output sample for each processor clock cycle. Architectures for pipelined FFT processors have been the subject of intensive research as the demand for real-time processing has increased. This effort has resulted in several architectures that offer varying degrees of complexity, memory size, control requirements and utilization efficiencies. Unfortunately, these architectures usually require a close synchronization between input data sampling and processor clock rate, which can limit their breadth of application.

Accordingly, what is needed in the art is a new FFT architecture that allows a wider disparity between input data sampling and processing clock rate.

### SUMMARY OF THE INVENTION

To address the above-discussed deficiencies of the prior art, the present invention is directed to an FFT architecture. In one embodiment, the FFT architecture includes a pipeline segment having a plurality of data-independent pipelines that receive different time-domain data samples and generate therefrom corresponding intermediate results. Additionally, the FFT architecture also includes a parallel segment, coupled to all of the pipelines, that receives the corresponding intermediate results and generates therefrom corresponding frequency-domain results.

In another aspect, the present invention provides a method of performing an FFT. The method includes initially receiving different time-domain data samples into a plurality of data-independent pipelines of a pipeline segment, the data-independent pipelines generating therefrom corresponding intermediate results. The method also includes subsequently receiving the corresponding intermediate results into a parallel segment coupled to all of the pipelines, the parallel segment generating therefrom corresponding frequency-domain results.

Since Orthogonal Frequency Division Multiplexing (OFDM) is an advantageous application for FFT, the present invention also provides, in yet another aspect, an OFDM receiver. The OFDM receiver includes an input section that is coupled to a receive antenna and an FFT section that is coupled to the receive section. The FFT section includes a pipeline segment having a plurality of data-independent pipelines that receive different time-domain data samples and generate therefrom corresponding intermediate results. The FFT section also includes a parallel segment, coupled to all of the pipelines, that receives the corresponding intermediate results and generates therefrom corresponding frequency-domain results. The OFDM receiver also includes an output section that is coupled to the FFT section.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an OFDM transmitter/receiver pair constructed in accordance with the principles of the present invention;

FIG. 2 illustrates a system diagram of an embodiment of a generalized, N-point pipeline/parallel FFT architecture constructed in accordance with the principles of the present invention;

FIG. 3 illustrates a system diagram of an embodiment of a 256-point pipeline/parallel FFT architecture constructed in accordance with the principles of the present invention;

FIG. 4 illustrates a system diagram of an embodiment of a 64-point FFT pipeline that may be employed in the pipeline segment of FIG. 3;

FIG. 5 illustrates an exemplary dataflow graph for a radix-2² FFT architecture wherein a 16-point transformation is shown for simplicity; and

FIG. 6 illustrates a dataflow diagram for an embodiment of a 4-point, radix-2 FFT parallel segment that may be employed in the FFT parallel segment 310 of FIG. 3.

### DETAILED DESCRIPTION

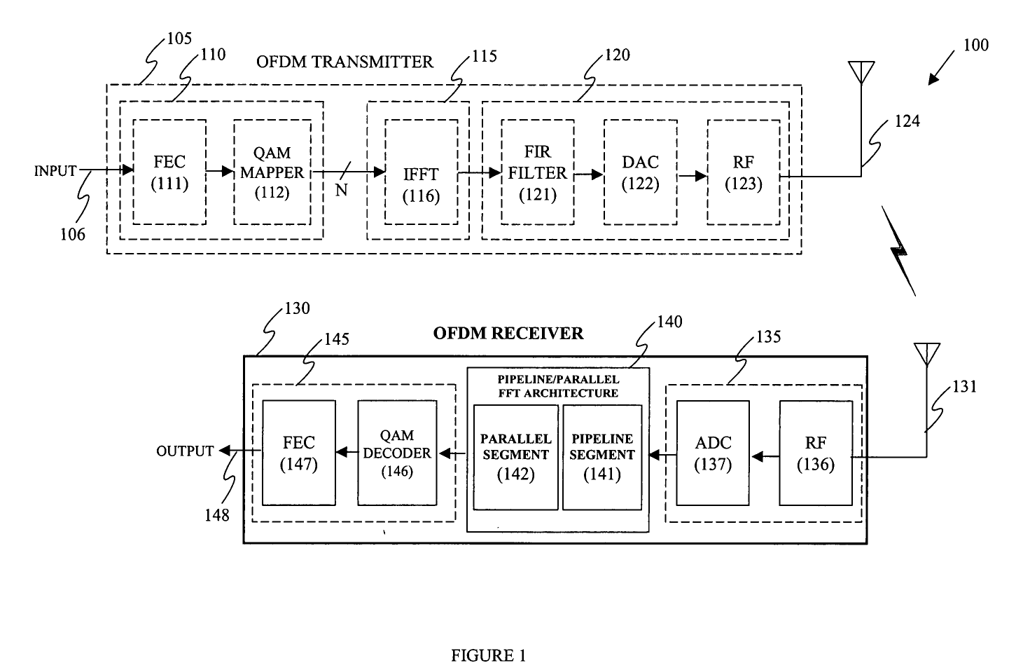

As previously stated, FFT finds advantageous use in OFDM receivers. Accordingly, the overall architecture of an OFDM receiver will now be described. Referring initially to FIG. 1, illustrated is a system diagram of an embodiment of an Orthogonal Frequency Division Multiplex (OFDM) transmitter/receiver pair, generally designated 100, constructed in accordance with the principles of the present invention. The OFDM transmitter/receiver pair 100 includes an OFDM transmitter 105 and an OFDM receiver 130. The OFDM transmitter 105 includes a transmitter input 106, a transmitter input section 110, a transmitter transform section 115, a transmitter output section 120 and a transmit antenna 124. The OFDM receiver 130 includes a receive antenna 131, a receiver input section 135, a pipeline/parallel fast Fourier transform (FFT) section 140, a receiver output section 145 and a receiver output 148.

The transmitter input section 110 includes a transmit forward error correction (FEC) stage 111, coupled to the transmitter input 106, and a quadrature amplitude modulation (QAM) mapper stage 112. The transmitter transform section 115 includes an N-point, inverse fast Fourier transform (IFFT) stage 116. The transmitter output section 120 includes a finite impulse response (FIR) filter stage 121, a digital-to-analog converter (DAC) stage 122 and a transmit radio frequency (RF) stage 123, which is coupled to the transmit antenna 124.

The receiver input section 135 includes a receive RF stage 136, which is coupled to the receive antenna 131, and an analog-to-digital converter (ADC) stage 137. The pipeline/parallel FFT section 140 includes a pipeline segment 141 and a parallel segment 142. The receiver output section 145 includes a QAM decoder stage 146 and a receive FEC stage 147, which is coupled to the receiver output 148.

The transmit FEC stage 111 provides forward error correction for a transmit input signal obtained from the transmitter input 106 and supplies an error-corrected input signal to the QAM mapper stage 112. The QAM mapper stage 112 codes the error-corrected transmit input signal for transmission and provides it to the IFFT stage 116. The N-point IFFT stage 116 transforms the error-corrected transmit input signal from the frequency domain to the time domain and supplies it to the FIR filter stage 121, where it is further filtered for transmission. The DAC stage 122 converts the transformed, filtered and error-corrected transmit input signal from a digital transmit signal to an analog transmit signal wherein it is further conditioned and modulated for transmission by the transmit RF stage 123 employing the transmit antenna 124.

The transmitted signal is received by the receive RF stage 136 employing the receive antenna 131. This analog, time-domain receive signal is conditioned, demodulated and supplied to the ADC stage 137 wherein it is converted from an analog signal to a digital signal and supplied to the pipeline/parallel FFT section 140. The pipeline/parallel FFT section 140 transforms the received signal from the time domain to the frequency domain employing both the pipeline segment 141 and the parallel segment 142. The QAM decoder 146 decodes the transformed receive signal wherein it is forward error corrected by the FEC stage 147 and provided as a receive output signal from the receiver output 148.

The pipeline segment 141 performs an initial portion of the FFT and the parallel segment 142 uses this initial portion to complete the FFT. The pipeline segment 141 employs a plurality of data-independent pipelines that receive different time-domain data samples and uses them to generate corresponding initial portions of the FFT as intermediate results of the complete FFT. The parallel segment 142 is coupled to the outputs of the plurality of data-independent pipelines wherein it receives the corresponding intermediate results and employs them to generate the complete FFT. This pipelined and parallel arrangement advantageously allows an FFT to be performed efficiently even when the data sample rate exceeds the available system clock rate. Of course, other applications of the pipeline/parallel FFT section 140 are well within the broad scope of the present invention.

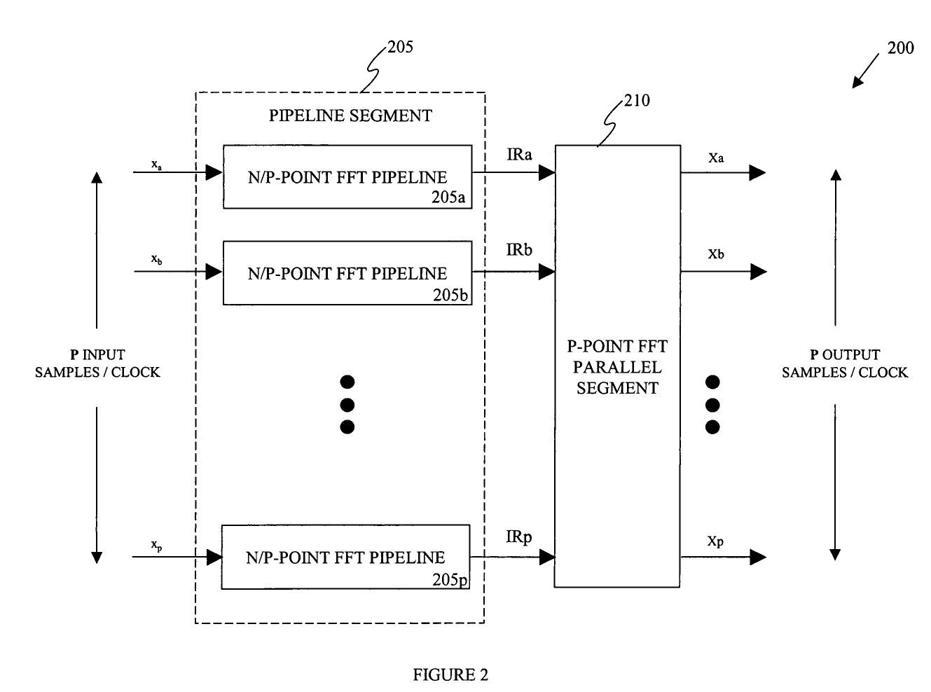

Having described one advantageous application for FFT, a novel FFT architecture will now be described. Accordingly, turning to FIG. 2, illustrated is a system diagram of an embodiment of a generalized, N-point pipeline/parallel FFT architecture, generally designated 200, constructed in accordance with the principles of the present invention. The pipeline/parallel FFT architecture 200 provides an N-point FFT conversion. Generally, the pipeline/parallel FFT architecture 200 receives a parallelism level P of time-domain input samples and provides a parallelism level P of frequency-domain output samples for each clock cycle associated with the transformation.

The pipeline/parallel FFT architecture 200 includes a pipeline segment 205 and a parallel segment 210. The pipeline segment 205 includes a plurality of data-independent FFT pipelines 205a-205p that receive a plurality of different, parallel, time-domain input data samples xₐ-xₚ, respectively. Each of the FFT pipelines 205a-205p receives a single time-domain data sample at a time. The plurality of FFT pipelines 205a-205p generate a corresponding plurality of parallel intermediate results IRa-IRp, as shown. The parallel segment 210 accepts the parallel intermediate results IRa-IRp and generates a corresponding plurality of parallel, frequency-domain output samples Xa-Xp, each clock cycle. These pluralities correspond to the parallelism level P. The parallelism level P for a particular application is based on both the time-domain data sample rate and the clock rate pertaining to the FFT application.

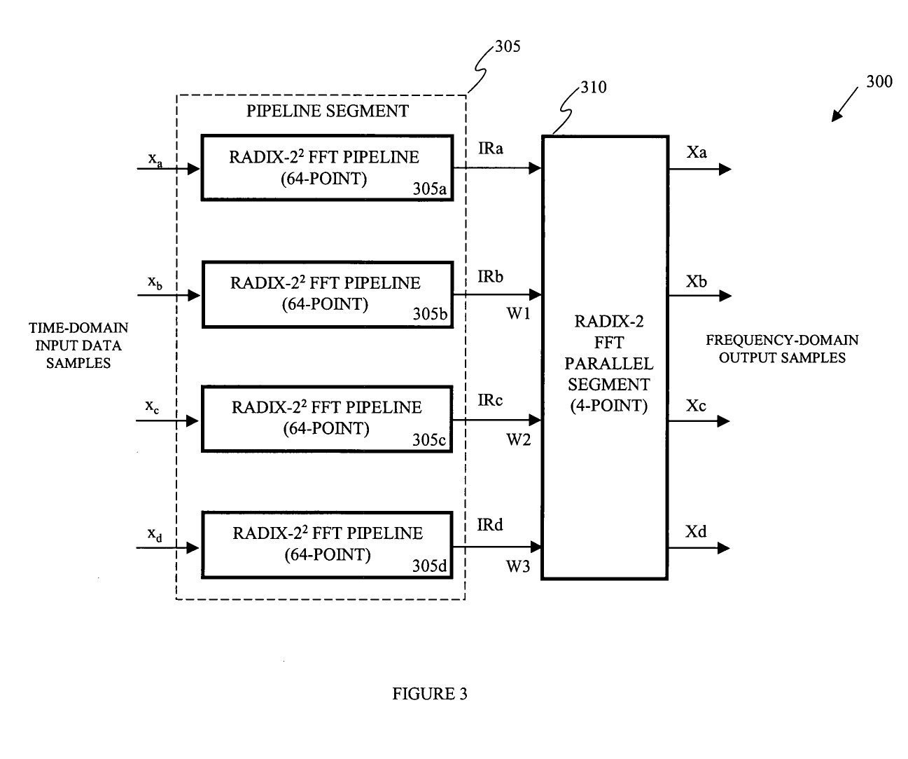

Turning now to FIG. 3, illustrated is a system diagram of an embodiment of a 256-point pipeline/parallel FFT architecture, generally designated 300, constructed in accordance with the principles of the present invention. The pipeline/parallel FFT architecture 300 includes a pipeline segment 305 and a parallel segment 310. The pipeline segment 305 includes first, second, third and fourth 64-point FFT pipelines 305a, 305b, 305c, 305d, which are collectively designated as the FFT pipelines 305a-305d. In the illustrated embodiment, each of the FFT pipelines 305a-305d employs a radix-2² FFT pipeline structure, and the parallel segment 310 provides a 4-point (i.e., parallelism level of four), radix-2 parallel FFT structure.

Representative first, second, third and fourth time-domain data samples xₐ, x_{b}, x_{c}, x_{d} are received by the FFT pipelines 305a-305d, respectively, and processed to provide respective first, second, third and fourth intermediate results IRa, IRb, IRc, IRd to the parallel segment 310. The second, third and fourth intermediate results IRb, IRc, IRd are weighted by first, second and third twiddle factors W1, W2, W3, and employed by the parallel segment 310 to provide first, second, third and fourth frequency-domain outputs Xa, Xb, Xc, Xd, as shown. Operation of each of these structures will be further described below.

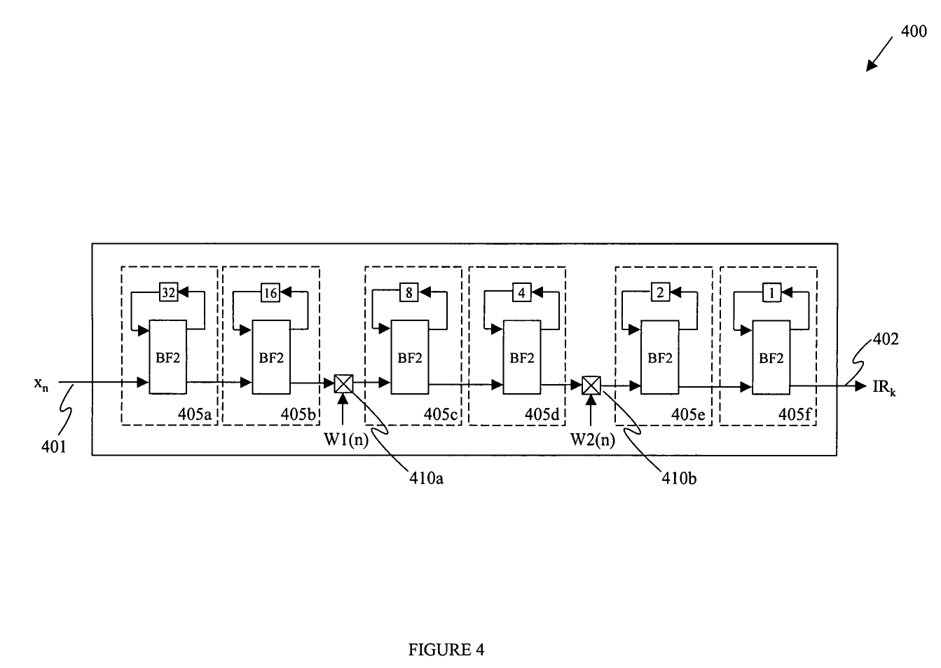

Turning briefly to FIG. 4, illustrated is a system diagram of an embodiment of a 64-point FFT pipeline, generally designated 400, that may be employed in the pipeline segment 305 of FIG. 3. In the illustrated embodiment, the 64-point FFT pipeline 400 is implemented in hardware and includes first, second, third, fourth, fifth and sixth butterfly structures 405a, 405b, 405c, 405d, 405e, 405f, which are collectively designated as the butterfly structures 405a-405f, and first and second multipliers 410a, 410b. The 64-point FFT pipeline 400 (which is exemplary of any of the FFT pipelines 305a-305d) receives time-domain input data samples xₙ at a pipeline input 401 and provides corresponding frequency-domain intermediate results IRₖ at a pipeline output 402. The first and second multipliers 410a, 410b allow appropriate multiplication by first and second twiddle factors W1(n), W2(n). In the illustrated embodiment, the butterfly structures 405a-405f are radix-2² single-path delay feedback architectures, which are well known in the pertinent art. Of course, other current or future developed pipeline architectures may be employed as appropriate to a particular application.

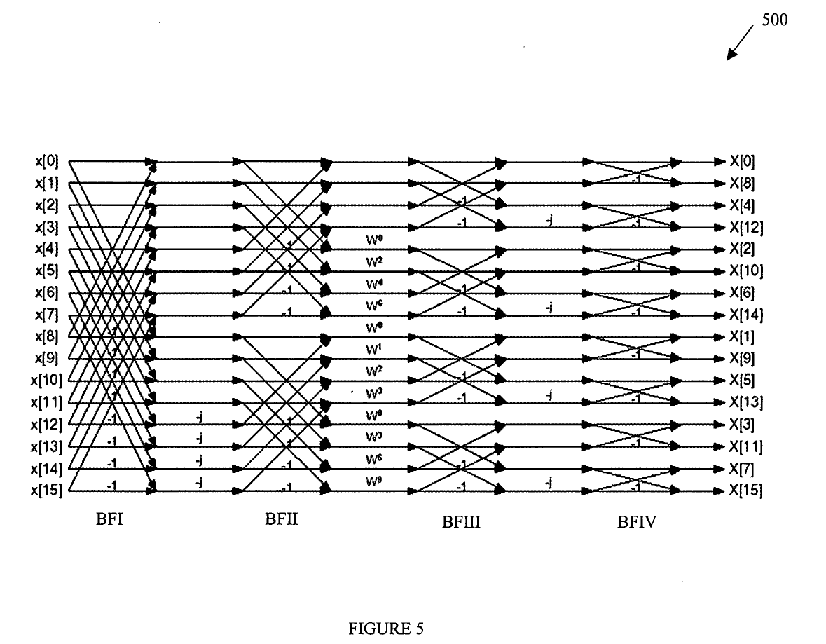

Turning briefly to FIG. 5, illustrated is an exemplary dataflow graph for a radix-2² FFT architecture, generally designated 500, wherein a 16-point transformation is shown for simplicity. The dataflow graph 500 employs 16 time-domain input data samples x[0]-x[15] and provides 16 frequency-domain transform outputs X[0]-X[15], as shown. The dataflow graph 500 illustrates four exemplary butterfly dataflow areas BFI, BFII, BFIII, BFIV that correspond to four butterfly structures. A pipelined architecture is obtained by folding the dataflow graph 500 by a factor of N/2 (i.e., a factor of eight). It can be noted that such a folding will require a total of log₂N (i.e., log₂16, or four) butterflies in pipelined architecture, as indicated. The third, fourth, fifth and sixth radix-2² butterfly structures 405c, 405d, 405e, 405f of FIG. 4 would provide such a structure. Additionally, the multiplicative operations in the dataflow graph 500 are such that only every other butterfly structure employs non-trivial multiplications involving the twiddle factors.

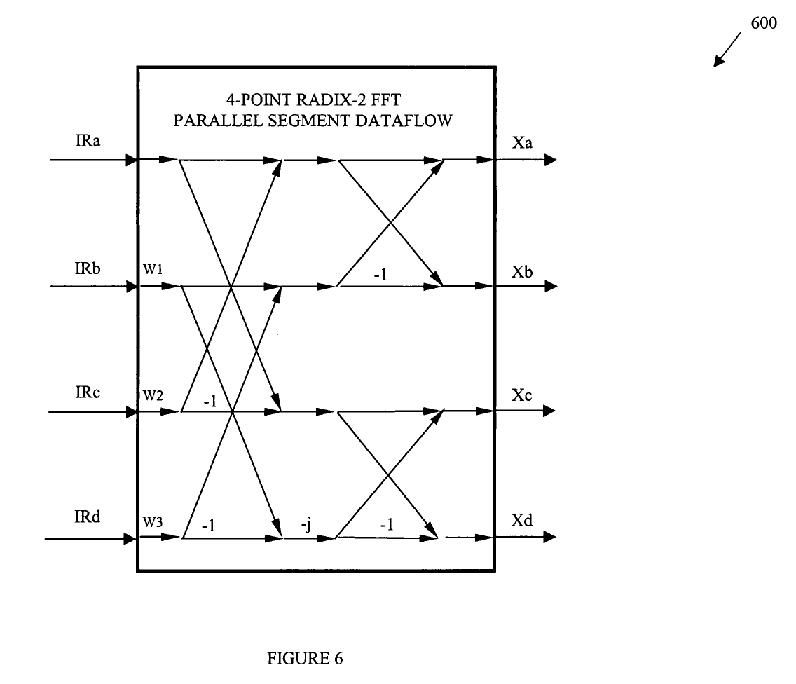

Turning briefly to FIG. 6, illustrated is a dataflow diagram for an embodiment of a 4-point, radix-2 FFT parallel segment, generally designated 600, that may be employed in the FFT parallel segment 310 of FIG. 3. The FFT parallel segment 600 receives frequency-domain intermediate results IRa-IRd from four pipelines and generates four frequency-domain outputs Xa-Xd during each clock time, employing the operations and dataflows shown.

Returning again to FIG. 3, the 64-point FFT pipelines 305a-305d employ the radix-2² architecture as discussed with respect to FIGS. 4 and 5. The radix-2² architecture provides a multiplicative complexity equivalent to that of a radix-4 architecture while maintaining adder complexity and lower critical-path properties of a radix-2 architecture, thereby facilitating pipeline implementation. The total number of complex multipliers in such a pipeline implementation is equal to log₄N−1. There are also two complex adders per stage, thereby requiring a total of 2log₂N complex adders.

The number of complex multipliers and complex adders for the pipeline/parallel FFT architecture 300 is based on the N-points of the FFT architecture and the parallelism level P. The number of complex multipliers N_{cmult} is given by:

N_{cmult}=P(the number of complex multipliers in an N/P-point pipelined FFT)+(P−1)+(the number of complex multipliers in a P-point parallel FFT).

Now, assuming a radix-2² architecture for the pipelined N/P-point FFT and a radix-2 architecture for the parallel P-point FFT, the number of complex multipliers N_{cmult} may be expressed more concisely by:

N_{cmult}=Plog₄(N/P)−1 where P=1, 2, 4, (1)

N_{cmult}=Plog₄(N/P)+1 where P=8, and (2)

N_{cmult}=Plog₄(N/P)+9, where P=16. (3)

It is assumed that a 1, 2 or 4-point parallel FFT requires no complex multipliers while an 8 or 16-point FFT requires 2 or 10 complex multipliers, respectively.

Similarly, the number of complex adders Ncadd is given by:

N_{cadd}=P(the number of complex adders in an N/P-point pipelined FFT)+(the number of complex adders in a P-point parallel FFT). Assuming a radix-2² architecture for the pipelined FFT and a radix-2 architecture for the parallel FFT, the number of complex adders N_{cadd} may be expressed more concisely by:

N_{cadd}=P(4logₐN−2log₄P), (4)

where it is assumed that each N/P-point pipelined FFT requires 4log₄(N/P) complex adders and that the P-point FFT requires 2log₄P complex adders. Table 1 indicates the number of complex multipliers and adders required to implement an N-point FFT having a parallelism level P.

TABLE 1
Complex Multiplier-Adder Requirements
of Pipeline/Parallel Architectures

| N | P | N_{cmult} | N_{cadd} |
|---|---|---|---|
| 64 | 1 | 2 | 12 |
| | 2 | 5 | 22 |
| | 4 | 7 | 40 |
| | 8 | 17 | 72 |
| 128 | 1 | 3 | 14 |
| | 2 | 5 | 26 |
| | 4 | 11 | 48 |
| | 8 | 17 | 88 |
| 256 | 1 | 3 | 16 |
| | 2 | 7 | 30 |
| | 4 | 11 | 56 |
| | 8 | 25 | 104 |
| 512 | 1 | 4 | 18 |
| | 2 | 7 | 34 |
| | 4 | 15 | 64 |
| | 8 | 25 | 120 |
| 1024 | 1 | 4 | 20 |
| | 2 | 9 | 38 |
| | 4 | 15 | 72 |
| | 8 | 33 | 136 |
| 2048 | 1 | 5 | 22 |
| | 2 | 9 | 42 |
| | 4 | 19 | 80 |
| | 8 | 33 | 152 |

The gate complexity of the pipeline/parallel FFT architecture is strongly dependant upon the number of complex mulitpliers that are required. Strength reduction transformations are well known in the pertinent art and can be used to implement complex multiplications by employing three real multipliers and five adders in place of four real multipliers and two real adders. Using a strength reduction transformation, an N-point pipeline/parallel FT architecture having a parallelism level P of can be implemented with 3N_{cmult} real multipliers and (2N_{cadd}+5N_{cmult}) real adders. Table 2 indicates the number of real multipliers and adders required to implement an N-point FFT having a parallelism level P employing strength reduction.

TABLE 2
Real Multiplier-Adder Complexity
of Pipeline/Parallel Architectures
after Strength Reduction

| | | Real | Real |
|---|---|---|---|
| N | P | Multipliers | Adders |
| 64 | 1 | 6 | 34 |
| | 2 | 15 | 69 |
| | 4 | 21 | 115 |
| | 8 | 51 | 229 |
| 128 | 1 | 9 | 43 |
| | 2 | 15 | 77 |
| | 4 | 33 | 151 |
| | 8 | 51 | 261 |
| 256 | 1 | 9 | 47 |
| | 2 | 21 | 95 |
| | 4 | 33 | 167 |
| | 8 | 75 | 333 |
| 512 | 1 | 12 | 56 |
| | 2 | 21 | 103 |
| | 4 | 45 | 203 |
| | 8 | 75 | 365 |
| 1024 | 1 | 12 | 60 |
| | 2 | 27 | 121 |
| | 4 | 45 | 219 |
| | 8 | 99 | 437 |
| 2048 | 1 | 15 | 69 |
| | 2 | 27 | 129 |
| | 4 | 57 | 255 |
| | 8 | 99 | 469 |

In summary, embodiments of the present invention directed to a pipeline/parallel FFT architecture, method of performing an FFT and an OFDM receiver employing the same have been presented. Advantages include allowing an FFT to be accomplished when a data sample rate exceeds an available system or transformation clock rate. The blending of pipeline and parallel FFT architectures provides an implementation trade-off between the complexity of an all parallel design and the constrained through-put of an all pipeline design as the number of points in an FFT conversion grows. Strength reduction transformations further allow a reduction in complex multiplications and additions.

Although the present invention has been described in detail, those skilled in the art should understand that they can make various changes, substitutions and alterations herein without departing from the spirit and scope of the invention in its broadest form.

What is claimed is:

1. A fast Fourier transform (FFT) architecture, comprising:
a pipeline segment having a plurality of data-independent pipelines that receive different time-domain data samples and generate therefrom corresponding intermediate results; and
a parallel segment, coupled to all of said pipelines, that receives said corresponding intermediate results and generates therefrom corresponding frequency-domain results.

2. The architecture as recited in claim 1 wherein each of said plurality of data-independent pipelines receives a single time-domain data sample at a time.

3. The architecture as recited in claim 1 wherein each of said data-independent pipelines is a radix-2² single-path delay feedback pipeline.

4. The architecture as recited in claim 1 wherein said parallel segment is a radix-2 segment.

5. The architecture as recited in claim 1 wherein a number of said plurality of data-independent pipelines for a particular application is based on both a time-domain data sample rate and a clock rate pertaining to said application.

6. The architecture as recited in claim 1 wherein a strength reduction transformation is employed to substitute real multipliers for complex multipliers.

7. The architecture as recited in claim 1 wherein said pipeline segment employs a hardware implementation.

8. A method of performing a fast Fourier transform (FFT), comprising:
initially receiving different time-domain data samples into a plurality of data-independent pipelines of a pipeline segment, said data-independent pipelines generating therefrom corresponding intermediate results; and
subsequently receiving said corresponding intermediate results into a parallel segment coupled to all of said pipelines, said parallel segment generating therefrom corresponding frequency-domain results.

9. The method as recited in claim 8 wherein each of said plurality of data-independent pipelines receives a single time-domain data sample at a time.

10. The method as recited in claim 8 wherein each of said data-independent pipelines is a radix-2² single-path delay feedback pipeline.

11. The method as recited in claim 8 wherein said parallel segment is a radix-2 segment.

12. The method as recited in claim 8 wherein a number of said plurality of data-independent pipelines for a particular application is based on both a time-domain data sample rate and a clock rate pertaining to said application.

13. The method as recited in claim 8 wherein a strength reduction transformation is employed to substitute real multipliers for complex multipliers.

14. The method as recited in claim 8 wherein said pipeline segment employs a hardware implementation.

15. An Orthogonal Frequency Division Multiplex (OFDM) receiver, comprising:
an input section that is coupled to a receive antenna;
a fast Fourier transform (FFT) section that is coupled to said receive section, including:
a pipeline segment having a plurality of data-independent pipelines that receive different time-domain data samples and generate therefrom corresponding intermediate results, and
a parallel segment, coupled to all of said pipelines, that receives said corresponding intermediate results and generates therefrom corresponding frequency-domain results; and
an output section that is coupled to said FFT section.

16. The receiver as recited in claim 15 wherein each of said plurality of data-independent pipelines receives a single time-domain data sample at a time.

17. The receiver as recited in claim 15 wherein each of said data-independent pipelines is a radix-2² single-path delay feedback pipeline.

18. The receiver as recited in claim 15 wherein said parallel segment is a radix-2 segment.

19. The receiver as recited in claim 15 wherein a number of said plurality of data-independent pipelines for a particular application is based on both a time-domain data sample rate and a clock rate pertaining to said application.

20. The receiver as recited in claim 15 wherein a strength reduction transformation is employed to substitute real multipliers for complex multipliers.

21. The receiver as recited in claim 15 wherein said pipeline segment employs a hardware implementation.
